(19) United States
(12) Patent Application Publication
(10) Pub. No.: US 2026/0338045 A1
(43) Pub. Date: Oct. 29, 2026

(54) METHOD FOR CREATING A FLUID BARRIER

(71) Applicant: Swellfix UK Limited, Westhill, Aberdeenshire (GB)

(72) Inventors: Jonathan ABBOTT, Aberdeen (GB); Li JIANG, Katy, TX (US); Eilidh Jean MCKAY, Aberdeen (GB); Suzanne STEWART, Cypress, TX (US)

(73) Assignee: Swellfix UK Limited, Westhill, Aberdeenshire (GB)

(21) Appl. No.: 19/112,419

(22) PCT Filed: Jul. 5, 2024
(86) PCT No.: PCT/EP2024/069111

§ 371 Date: Mar. 17, 2025

(30) Foreign Application Priority Data
Jul. 7, 2023 (GB) 2310506.7
Jul. 7, 2023 (GB) 2310507.5
Jul. 7, 2023 (GB) 2310508.3

(51) Int. Cl. E21B 33/138

(52) U.S. Cl. CPC E21B 33/138

(57) ABSTRACT

A method for creating a fluid barrier in a wellbore or a geological formation surrounding the wellbore includes delivering a plurality of swellable particulates into the wellbore and into a first zone in the wellbore or the formation, the plurality of swellable particulates configured to volumetrically swell to create a fluid barrier in response to exposure to a swelling activator. The method further includes delivering a plurality of fibre elements into the wellbore and into the first zone, the fibre elements configured to adhere to one another to create a web arrangement for constraining movement of the swellable particulates in response to exposure to an adhesion activator.

### FIELD

The present disclosure relates to a method for creating a fluid barrier. In particular, the present disclosure relates to a method for creating a fluid barrier in a wellbore or a geological formation surrounding the wellbore.

### BACKGROUND

Downhole operations may require fluid barriers to be created for a number of applications. For instance, in a drilling operation, drilling fluid is typically pumped through a drillstring and returned to surface via an annulus between the drillstring and the formation. In some cases, the formations may comprise a high permeability zone (known as a “loss zone” or “thief zone”) causing drilling fluid to be lost to the formation resulting in a partial or total loss of fluid returns at surface. This not only causes a loss of well control but also represents a significant financial loss. In addition, after a drilling operation has been completed, a cementing operation may be performed in which a cement slurry is pumped into an annulus between the wellbore and a casing in the wellbore. If the loss zone of the formation is not properly treated, the cement slurry may also be lost to the formation resulting in further financial losses and potential faults occurring, such as the creation of fluid pathways (e.g. to other parts of the well) which may detrimentally impact well integrity. In other applications, fluid barriers may be required to restore well integrity after failure of tubulars, casing or sealing elements in the well. In these circumstances, fluid barriers may be created to restore seal integrity to enable continued production or allow safe production until a workover can be performed to remediate the issue. More generally, fluid barriers may be created to isolate and seal segments of the well, e.g. by creating annular seals between tubulars and casing in the well.

### SUMMARY

An aspect of the present disclosure relates to a method for creating a fluid barrier in a wellbore or a geological formation surrounding the wellbore, comprising:
delivering a plurality of swellable particulates into the wellbore and into a first zone in the wellbore or the formation, the plurality of swellable particulates configured to volumetrically swell to create a fluid barrier in response to exposure to a swelling activator; and
delivering a plurality of fibre elements into the wellbore and into the first zone, the fibre elements configured to adhere to one another and create a web arrangement for constraining movement of the swellable particulates in response to exposure to an adhesion activator.

The web arrangement created by the fibre elements may confine the swellable particulates in the first zone to prevent the swellable particulates from moving to a more dispersed, relaxed position during and after the swelling process, thereby enhancing the fluid barrier created by the swellable particulates. The fluid barrier created by the swellable particulates may provide a number of preferential functions depending on the application. For instance, the fluid barrier may be used to reduce fluid losses to the formation, for example in a drilling operation, a cementing operation, a workover operation, etc. In further applications, the fluid barrier may be used to create a seal in the wellbore. For example, the fluid barrier may be used to create an annular seal between a tubular and casing in the wellbore, e.g. to separate the wellbore into segments. In this regard the fluid barrier may function as a packer element. Alternatively, the fluid barrier may be created to restore the integrity of a sealing element in the wellbore, such as cement, a cement plug, annular packer, damaged casing, damaged tubing, etc. The fluid barrier may be applied as a permanent solution or a temporary solution to control losses, which may enable workover activities to be performed.

The web arrangement created by the fibre elements may comprise any shape or structure capable of constraining movement of the swellable particulates in the first zone. The web arrangement created by the fibre elements may comprise an interconnected network of fibre elements in the first zone. The web arrangement created by the fibre elements may comprise one or more groups or clusters of fibre elements in the first zone. The size of the clusters may be controlled by adjusting a ratio (e.g. a stoichiometric ratio) of the swellable particulates to fibre elements.

The method may comprise exposing the fibre elements to the adhesion activator to create the web arrangement of fibre elements in the first zone. The method may comprise exposing the swellable particulates to the swelling activator to create the fluid barrier in the first zone and establish a restriction against fluid flow.

The fluid barrier created by the swellable particulates may provide a seal or plug. The first zone may be defined as a seal or plug zone.

The first zone may be a zone in the formation. The first zone may be a high permeability zone (i.e. a loss zone or thief zone) in the formation. The first zone may be a zone in which fluid is lost to the formation during a drilling operation, a cementing operation, a workover operation, etc. The method may comprise delivering the swellable particulates and fibre elements into the first zone to reduce or prevent fluid losses through the first zone.

The first zone may comprise a first fracture in the formation. The swellable particulates and fibre elements may be delivered into the first fracture. The swellable particulates and fibre elements may be delivered into an existing fracture. The existing fracture may be a naturally existing fracture in the formation or a fracture created by a previous operation performed in the first zone.

The formation may comprise a permeability capable of permitting fluid to migrate or flow through the formation. The method may comprise obstructing a fluid flow in the first zone with the swellable particulates. The fluid may be a liquid, gas or supercritical fluid. The fluid barrier may be defined as a hydraulic barrier.

The method may comprise performing an operation in a second zone of the formation. The second zone may be adjacent the first zone. The operation in the second zone may be performed before or after the swellable particulates and fibre elements have been delivered into the first zone. The method may comprise obstructing a fluid flow from the second zone with the swellable particulates and fibre elements in the first zone.

The operation performed in the second zone may comprise creating a second fracture in the second zone. The operation performed in the second zone may comprise a hydraulic fracturing operation.

The operation performed in the second zone may comprise extracting a formation product from the formation. The formation product may comprise a geothermal fluid. The formation product may comprise hydrocarbons (e.g. oil, gas and/or coal). The method may comprise flowing oil and/or gas from the geological formation into the wellbore via the second fracture for production at surface.

The operation performed in the second zone may involve injecting a gas or supercritical fluid into the formation, e.g. for storage.

The operation performed in the second zone may involve injecting a fluid or gas to improve hydrocarbon recovery, e.g. as part of an enhanced oil recovery (EOR) operation.

The first zone may be a lower zone and the second zone may be an upper zone, or vice versa. Where the first zone is an upper zone (and thus located closer to surface than the second zone), the fluid barrier provided in the first zone may reduce or prevent fluids (such as, carbon dioxide) from migrating past the first zone and towards the surface.

In some examples, the first zone may be associated with a region of the formation that has been depleted and is producing unwanted fluids, such as water, gas or supercritical fluid. The second zone may be associated with a region of the geological formation containing a formation product (e.g. hydrocarbons or a geothermal heat) to be extracted from the geological formation.

The first zone may be located around a first portion of the wellbore. The second zone may be located around a second portion of the wellbore, e.g. uphole or downhole of the first portion. Alternatively, the second zone may be located around a portion of a different wellbore, e.g. located adjacent the wellbore of the first zone.

The first zone may be a zone in the wellbore.

The first zone may be an annulus in the wellbore, for example between tubing and casing in the wellbore, or between casing and the surrounding formation, etc. The method may comprise delivering the swellable particulates and fibre elements into the first zone to separate the wellbore into segments. The fluid barrier created may be an annular fluid barrier.

The first zone may comprise a defective seal element, such as a packer, which may be allowing a fluid flow through the annulus. The method may comprise delivering the swellable particulates and fibre elements into the first zone to restore a sealing function of the defective seal element, or to replace the seal element entirely.

The first zone may comprise a defective screen element. The method may comprise delivering the swellable particulates and fibre elements into the first zone to isolate the screen element. The swellable particulates and fibre elements may be configured to prevent fines or solids from passing through the defective screen element.

The first zone may comprise a perforated tubular element in the wellbore, for example a perforation in a casing in the wellbore. The method may comprise delivering the swellable particulates and fibre elements into the first zone to plug or seal the perforation.

The method may comprise transporting the swellable particulates and fibre elements through the wellbore as part of a drilling operation to prevent or reduce losses to the formation. The method may comprise transporting the swellable particulates and fibre elements downhole in a drilling fluid.

The method may comprise transporting the swellable particulates and fibre elements through the wellbore as part of a cementing operation to prevent or reduce losses to the formation. The method may comprise transporting the swellable particulates and fibre elements downhole in a cement slurry.

The method may comprise transporting the swellable particulates and fibre elements through the wellbore as part of a workover operation to prevent or reduce losses to the formation. The method may comprise transporting the swellable particulates and fibre elements downhole in a workover fluid.

The method may comprise ceasing an operation (a drilling operation, a cementing operation, a workover operation, etc.) and delivering the swellable particulates and fibre elements into the wellbore to prevent or reduce losses to the formation. The method may comprise continuing the operation after the swellable particulates and fibre elements have been delivered into the wellbore.

The swelling activator and adhesion activator may comprise the same activator or different activators. Where the swelling activator and adhesion activator comprise different activators, this may allow for independent control of creation of the web arrangement and swelling of the swellable particulates.

The swelling activator may be any suitable activator. The swelling activator may be or comprise a fluid. The swelling activator may be or comprise water. The swelling activator may be or comprise a water-based fluid. The swelling activator may be or comprise an oil.

The swellable particulates may comprise a swellable material configured to volumetrically swell in response to exposure to the swelling activator.

The swellable particulates may be configured to swell by osmosis. In this regard the swellable particulates may be defined as osmotic swellable particulates. The swellable particulates may comprise a material having a composition such that permeation of the swelling activator (e.g. water) into the swellable particulates will occur as a result of osmosis.

The adhesion activator may be any suitable activator. The adhesion activator may be defined by a condition change, such as a change in temperature or pressure. The adhesion activator may comprise a fluid or chemical. In a preferred example, however, the adhesion activator is or is defined by an activation temperature.

The fibre elements may comprise or exhibit a selectively adhesive (e.g. tacky) characteristic. The selectively adhesive characteristic may enable the fibre elements to adhere to one another and create the web arrangement.

The fibre elements may be configured to not adhere to one another until the fibre elements have been exposed to the adhesion activator. This may allow the fibre elements to be transported downhole without the risk of plugging the wellbore and/or surface and downhole equipment associated with the wellbore.

The method may comprise delivering the swellable particulates and fibre elements into the first zone in a comingled state.

The method may comprise exposing the fibre elements to the adhesion activator before, during or after exposing the swellable particulates to the swelling activator to create the web arrangement of fibre elements. In a preferred example, the method comprises exposing fibre elements to the adhesion activator before exposing the swellable particulates to the swelling activator to allow the web arrangement of fibre elements to be created in the first zone before the swellable particulates start to swell.

The method may comprise delivering the swellable particulates and fibre elements into the wellbore in a number of stages or “pills”, i.e. a small quantity of fluid used for a specific task that another fluid (e.g. a drilling fluid) is unable to perform.

In a first stage, the method may comprise delivering a first plurality of fibre elements into the wellbore and into the first zone. The first plurality of fibre elements may be exposed to the adhesion activator to create a first web arrangement of fibre elements in the wellbore, for example at a distal region (e.g. relative to the wellbore) of the first zone. The first web arrangement may provide a receiving area for the swellable particulates to be deposited on.

In a subsequent second stage, the method may comprise delivering the swellable particulates into the wellbore. The swellable particulates may be delivered into the wellbore with or without fibre elements.

In a subsequent third stage, the method may comprise delivering a second plurality of fibre elements into the wellbore. The second plurality of fibre elements may be exposed to the adhesion activator to create a second web arrangement of fibre elements, for example at a proximal region (e.g. relative to the wellbore) of the first zone. The second web arrangement of fibre elements may provide additional stability and resist movement of the swellable particulates back into the wellbore, e.g. due to a pressure from the formation acting on the swellable particulates.

In a subsequent fourth stage, the swellable particulates may be exposed to the swelling activator to create the fluid barrier in the first zone between the first and second web arrangements of fibre elements. The first and second web arrangements of fibre elements may function to contain the swellable particulates in the first zone between the proximal and distal regions of the first zone.

The web arrangement of fibre elements may be configured to comprise a strength capable of withstanding a pressure differential. As the swellable particulates swell, the swellable particulates may function to further increase the strength of the web arrangement by pushing the fibre elements closer to another.

The method may comprise transporting the swellable particulates and fibre elements downhole via a conduit in the wellbore, such as a drill pipe, coiled tubing, a liner, etc., in the wellbore. The conduit may comprise a port for the swellable particulates and fibre elements to be delivered into the first zone. The method may comprise transporting the swellable particulates and fibre elements downhole in a slotted liner. A slotted liner may allow the swellable particulates and fibre elements to be deposited (e.g. spotted) in certain areas of the first zone. For example, where a section of the wellbore is producing an unwanted fluid, such as water, the swellable particulates and fibre elements may be spotted in that zone to seal and prevent influx.

The method may comprise transporting the swellable particulates and fibre elements downhole in a carrier fluid. The carrier fluid, swellable particulates and fibre elements may form a slurry.

The swellable particulates and fibre elements may be mixed with the carrier fluid for subsequent delivery into the wellbore in a premixed state. Alternatively, the swellable particulates and fibre elements may be injecting or incorporated into the carrier fluid as the carrier fluid flows (e.g. is pumped) towards the wellbore.

The carrier fluid may be configured to limit or prevent swelling of the swellable particulates, e.g. as the swellable particulates are transported through the wellbore and into the geological formation. In particular, where the swellable particulates are water swellable particulates, the carrier fluid may comprise a saline solution, e.g. a high-salinity brine or other solvent. This may allow for swelling of the swellable particulates to be delayed until the swellable particulates are delivered into the first zone.

As noted above, the method may comprise delivering the swellable particulates and fibre elements into the wellbore in a number of stages. The method may comprise delivering the fibre elements into the wellbore in a first carrier fluid. The method may comprise delivering the swellable particulates into the wellbore in a second carrier fluid. The first and second carrier fluids may be or comprise the same fluid. The first and second carrier fluids may be or comprise different fluids. The first carrier fluid may be configured to encourage bridging of the fibre elements in the first zone. The second carrier fluid may be configured to encourage bridging of the swellable particulates in the first zone. At least one of the first and second carrier fluids may comprise the adhesion activator. At least one of the first and second carrier fluids may comprise the swelling activator.

The swellable particulates may be configured to swell between 10% and 400% of their completely unswelled size, for example between 10% and 200% of their completely unswelled size, for example between 10% and 100% of their completely unswelled size.

The swellable particulates may comprise a polymer. The swellable particulates may comprise a rubber.

The swellable particulates may comprise a material configured to provide a desired swell strength, longevity under downhole conditions, and/or chemical resistance. The swellable particulates may be configured to swell under formation conditions, such as formation pressures and temperatures.

The swellable particulates may comprise a granular material. The swellable particulates may comprise a non-degradable material. The swellable particulates may comprise a material configured to be unreactive to certain substances. The certain substances may include substances that the swellable particulates are expected to encounter during the operational lifetime of the swellable particulates. In other words, the swellable particulates may be configured to be substantially unaffected by exposure, i.e. not degrade when exposed, to the substances that the swellable particulates are expected to encounter during the operational lifetime of the swellable particulates.

The rate of swelling may be modulated by manipulating an osmotic pressure differential across an interface between the swellable particulates and the carrier fluid, thus a rate of fluid penetrating into the swellable particulates can be controlled. This may allow for the rate at which the swellable particulates swell to be substantially reduced as the swellable particulates are transported through the wellbore and into the first zone.

The carrier fluid may be any suitable fluid. The carrier fluid may be a fluid used in a drilling process, a cementing process, a workover process, etc. The carrier fluid may comprise one or more additives. For example, the carrier fluid may comprise a viscosity agent, such as a thickener, to assist with suspending the swellable particulates and/or proppants in the carrier fluid. The carrier fluid may comprise one or more surfactants. The carrier fluid may be or comprise water. The carrier fluid may be or comprise a water-based fluid.

In some examples, the carrier fluid may comprise the swelling activator. In this regard the swellable particulates may partially swell as the carrier fluid transports the swellable particulates through the wellbore and into the first zone. The method may comprise retaining the carrier fluid in the first zone for a certain duration of time to achieve a desired amount of swelling. The method may comprise delivering an additional volume of the carrier fluid (when comprising the swelling activator) into the wellbore and into the first zone after the swellable particulates have been provided in the first zone to achieve a desired amount of swelling of the swellable particulates.

The swellable particulates may comprise a coating. The coating may be configured to degrade after a certain duration of time. The coating may be configured to degrade when exposed to a certain amount of a degrading agent. The degrading agent may comprise the same composition as the swelling activator.

The coating may be configured to degrade at a predetermined point in a process, e.g. in a drilling process, a cementing process, a workover process, etc. The coating may be configured to degrade when the swellable particulates have been provided in the first zone. This may prevent premature swelling of the swellable particulates (i.e. swelling to an undesirable extent) prior to reaching the first zone, which may otherwise inhibit the flow of the treatment fluid through the wellbore and into the first zone. The coating may comprise a material with a low molecular weight, such as a mineral oil. The coating may comprise a molecular weight in a range of 100 to 500 Da, preferably in a range of 125 to 400 Da and more preferably in a range of 150 to 300 Da. A material with a low molecular weight may form a temporary barrier between the swellable particulates and the swelling activator, and may eventually give way under shear and increasing temperatures.

The swellable particulates may be configured to swell at a certain swell rate, for example when exposed to the swelling activator. The swell rate of the swellable particulates may be configured to provide the swellable particulates in a swelled condition after a certain duration of time, or at a certain point in the method, e.g. when provided in the first zone. The swell rate of the swellable particulates may prevent premature swelling of the swellable particulates (i.e. swelling to an undesirable extent) prior to reaching the first zone.

The method may comprise utilising a swelling activator existing in the formation or wellbore and exposing the swellable particulates to the swelling activator when delivered into the first zone.

The swellable particulates may be configured to remain in the swelled condition for a required time duration, such as a perceived operational lifetime of the swellable particulates. The operational lifetime of the swellable particulates may be based on one or more factors, such as the expected operational lifetime of the well (e.g. from production to abandonment), the expected operational lifetime of a reservoir associated with the well, or the expected operational lifetime of a neighbouring well, etc. In this regard the swellable particulates may be considered as a permanent installation.

The swellable particulates may be configured for effective transport through the wellbore and into the first zone. For example, the swellable particulates may comprise a grain size distribution between 5 and 1000 mesh, more preferably between 10 and 100 mesh, when in an unswelled condition. However, the size of the swellable particulates may vary depending on the application.

The swellable particulates may comprise one or more of a sphere, flake, cylinder, star, cube, etc. The swellable particulates may comprise the same size and shape, or different sizes and shapes.

Where the swellable particulates and fibre elements are delivered into the wellbore together, a concentration or weight of the fibre elements may be based on a concentration or weight of the swellable particulates. For example, a weight of the fibre elements may be in a range from 0.5% to 10% of the total weight of swellable particulates.

The adhesive characteristic of the fibre elements may be configured for activation at an anticipated temperature of the first zone, for example a naturally existing temperature of the formation. In one example, the adhesive characteristic of the fibre elements is activated at an activation temperature in a range between 60 to 200 degrees Celsius. The fibre elements may comprise or be similar to fibre elements described in WO 2010/075248 A1, which is incorporated herein by reference.

The swellable particulates may be configured to adhere to one another and/or the fibre elements after absorbing the swelling activator. The swellable particulates may be configured to exhibit or comprise an adhesive characteristic (e.g. a tacky characteristic) after absorbing the swelling activator. Where the swellable particulates comprise water swellable particulates, and have absorbed the swelling activator (i.e. water), the swellable particulates may be configured to adhere to one another by virtue of a hydrogen bond (H-bond) between adjacent swellable particulates. In this respect a hydrogen bond network may be formed by the swellable particulates. The swellable particulates may be configured to form clusters with one another after absorbing the swelling activator.

The fibre elements may be configured to withstand exposure to certain substances that the fibre elements may encounter during their operational lifetime, including expected downhole pressures, temperatures, reservoir fluids and chemicals used during typical operations, such as stimulation operations.

The fibre elements may be configured to degrade upon exposure to a degrading agent. The degrading agent may comprise one or more additives or chemicals. This may provide for the web arrangement of fibre elements to be degraded upon delivery of the degrading agent to the fibre elements in the first zone.

When the swellable particulates are swelled in the first zone, the swellable particulates may be configured to remain in the first zone after the web arrangement of fibre elements has been separated due to no longer being exposed to the adhesion activator.

The fibre elements may be configured to be substantially non-swellable, i.e. completely non-swellable or swellable to a negligible extent.

The fibre elements may comprise various sizes. The fibre elements may comprise a variety of cross-sectional shapes, e.g. circular, prismatic, cylindrical, lobed, rectangular or polygonal. The fibre elements may comprise a straight profile or an undulating profile.

The fibre elements may be configured to provide a large surface area relative to a volume of the fibre elements. The fibre elements may comprise an aspect ratio of at least 2:1, for example 10:1, 100:1, 1000:1, etc. Larger aspect ratios (e.g. having aspect ratios of 10:1 or more) may help promote the formation of a network of the fibre elements, as well as allowing for more swellable particulates to adhere to external surfaces of the fibre elements.

The fibre elements may have a length in a range of 1 to 25 mm. The fibre elements may comprise a cross-sectional dimension of up to 500 micrometres.

The fibre elements may comprise one or more additives and/or coatings, for example to impart desirable properties such as handling, processability, stability and dispersibility.

The fibres elements may comprise one or more surfactants, e.g. emulsifiers. The surfactants may be configured to improve the dispersibility or handling of the fibre elements. In some examples, the surfactants may be added to the fibre elements in a range of 0.05 to 3 percent by weight of the fibre elements.

The fibres elements may comprise one or more polymeric dispersing agents. The polymeric dispersing agents may be configured to promote the dispersion of the fibre elements in a chosen medium and at desired application conditions (e.g., extreme pH and/or elevated temperatures). In some examples, the polymeric dispersing agents may be added to the fibre elements in a range of 0.05 to 5 percent by weight of the fibre elements.

The fibres elements may comprise one or more antioxidants. The antioxidants may be configured to retain useful properties of the fibre elements through their operational life. In some examples, the antioxidants may be added to the fibre elements in a range of 0.05 to 1.5 percent by weight of the fibre elements.

The fibres elements may comprise one or more of colorants (e.g. dyes and pigments), fillers (e.g. carbon black, clays, and silica) and surface applied materials (e.g. waxes, talcs, erucamide, gums, and flow control agents), for example to help improve storage, transportation and handling.

The fibre elements may comprise a core-shell configuration.

The core may be configured to provide rigidity. The shell may be configured to comprise or exhibit the adhesive characteristic of the fibre elements referred to hereinabove.

The shell may comprise a polymeric material or a blend of polymeric materials. The shell may comprise one or more other additives, e.g. a plasticizer, a superabsorbent polymeric material, etc. The shell may comprise at least one of a thermoplastic composition and a curable resin. The shell may comprise or be formed of an ethylene acid copolymer, which may be partially neutralized. In some examples, the shell may comprise or be formed of a product sold under the trade name SURLYN™ Ionomers sold by DOW, such as SURLYN™ 1605 Ionomers or SURLYN™ 1702 Ionomers.

The shell may comprise a softening point. A softening temperature of the shell may be configured to be slightly greater than an anticipated temperature of the first zone. The desired softening temperature can be achieved by selecting an appropriate single polymeric material or combining two or more polymeric materials. Exemplary polymeric materials may have or may be modified to have a softening temperature in the range of 60 to 150 degrees Celsius.

The fibre elements may be configured to bond without significant loss of their core-shell configuration or shape. The fibre elements may be configured to maintain a spatial relationship of the core and shell after the adhesive characteristic of the fibre elements has been activated.

In some examples, the shell may comprise an elastic modulus of less than 3×105 N/m2 at a frequency of about 1 Hz at a temperature of at least 60 degrees Celsius.

The core may comprise blends of polymers and/or other components. The core may have a melting point at a temperature in a range of 130 and 220 degrees Celsius. The core may comprise at least one of a thermoplastic composition and a curable resin. In some examples, the core may comprise or be formed of a nylon, such as Nylon66.

The fibre elements may be formed using techniques known in the art for making core-shell fibres, such as fibre spinning. The fibre elements may be crosslinked, for example through radiation or chemical means.

The method may comprise delivering a filler material into the first zone. The filler material may be or comprise sand (for example, a fine mesh sand), glass, etc. The swellable particulates may be combined with the filler material before delivering the swellable particulates into the wellbore. The filler material may be configured to be transported downhole in the carrier fluid. The filler material may reduce the mass of swellable particulates required to perform a particular treatment process. The swellable particulates may be configured to swell against or around the filler material. At least one of the filler material and swellable particulates may be configured to be at least partially deformable, e.g. when engaged with one another.

The method may comprise flowing or displacing the carrier fluid from the first zone, e.g. back into the wellbore. For instance, the carrier fluid may flow or be displaced by reducing a pressure of the carrier fluid, e.g. from surface. Alternatively, or in addition, a natural pressure of the formation may act on the carrier fluid to force the carrier fluid out of the first zone.

The method may comprise chasing or over-flushing the carrier fluid using a chaser fluid, e.g. which may be delivered into the wellbore after the swellable particulates have been delivered into the wellbore. This may force the carrier fluid to be displaced from the first zone further into the formation, which may help accelerate in-situ swelling of the swellable particulates in the first zone (for example, where the carrier fluid and/or chaser fluid comprise the swelling activator).

The method may comprise retaining the swellable particulates in the first zone while flowing or displacing the carrier fluid from first zone.

The method may comprise forming a bridge with at least a portion of the swellable particulates and/or fibre elements at or near an entrance or opening of a fracture (e.g. at an interface between the formation and the wellbore). Bridging is a phenomenon which occurs where particulates of a certain size simultaneously arrive at a constriction in a flow path and form a bridge or arch across the constriction, thereby obstructing the flow path and preventing further particulates from travelling past the constriction. Bridging is dependent on parameters including the size ratio between the particulates and the constriction, the concentration of particles, the carrier fluid viscosity, the presence of other solid additives and a flow velocity of the particulates. The method may comprise delivering the swellable particulates and fibre elements into a fracture and bridging the swellable particulates and/or fibre elements at the entrance or opening of the fracture to prevent or reduce fluid loss into the fracture.

The method may comprise providing the swellable particulates and/or fibre elements with a certain size based on at least one of formation pore dimensions and expected dilated fracture dimensions. The swellable particulates and/or fibre elements may comprise a certain shape, size and/or size distribution so that the swellable particulates and/or fibre elements bridge with one another inside a range of fracture geometries. The method may comprise delivering the swellable particulates and fibre elements into the fracture at a certain flowrate in a carrier fluid optimised to encourage bridging of the swellable particulates and/or fibre elements at the fracture entrance or opening.

An aspect of the present disclosure relates to a method for creating a fluid barrier in a wellbore or a geological formation surrounding the wellbore, comprising:
delivering a plurality of swellable particulates into the wellbore and into a first zone in the wellbore or the formation, the plurality of swellable particulates configured to volumetrically swell to create a fluid barrier in response to exposure to a swelling activator; and
delivering a plurality of fibre elements into the wellbore and into the first zone, the fibre elements configured to adhere to one another to constrain movement of the swellable particulates in the first zone in response to exposure to an adhesion activator.

Another aspect of the present disclosure relates to a method for creating a constriction in a wellbore or a geological formation surrounding the wellbore, comprising:
delivering a plurality of fibre elements into the wellbore and into a first zone in the wellbore or the formation, the fibre elements configured to adhere to one another and create a web arrangement for constraining movement of a particulate in the first zone in response to exposure to an adhesion activator.

The particulate may comprise a plurality of swellable particulates in accordance with the description above. Alternatively, the particulate may comprise one or more of a plurality of proppants, a gravel pack, a filtration medium, etc.

Another aspect of the present disclosure relates to a fluid treatment package comprising:
a plurality of swellable particulates for delivery into a wellbore and into a first zone in the wellbore or the formation, the plurality of swellable particulates configured to volumetrically swell to create a fluid barrier in response to exposure to a swelling activator; and
a plurality of fibre elements for delivery into the wellbore and into the first zone, the fibre elements configured to adhere to one another and create a web arrangement for constraining movement of the swellable particulates in response to exposure to an adhesion activator.

It will be appreciated that features described in relation to one aspect may be equally combined with any other aspect described herein.

### BRIEF DESCRIPTION OF THE DRAWINGS

These and other aspects of the present disclosure will now be described, by way of example only, with reference to the accompanying drawings, in which:

FIGS. 1 to 4 provide a schematic illustration of a method for creating a fluid barrier in a geological formation;

FIGS. 5 to 8 provide a schematic illustration of a method for creating a fluid barrier in an annulus of a wellbore; and

FIGS. 9 to 12 provide a schematic illustration of another method for creating a fluid barrier in an annulus of a wellbore; and

FIGS. 13 and 14 are images taken from a laboratory test performed by the present inventors demonstrating the plugging effects obtainable with and without fibre elements; and

FIG. 15 is a summary chart of the laboratory tests.

### DETAILED DESCRIPTION OF THE DRAWINGS

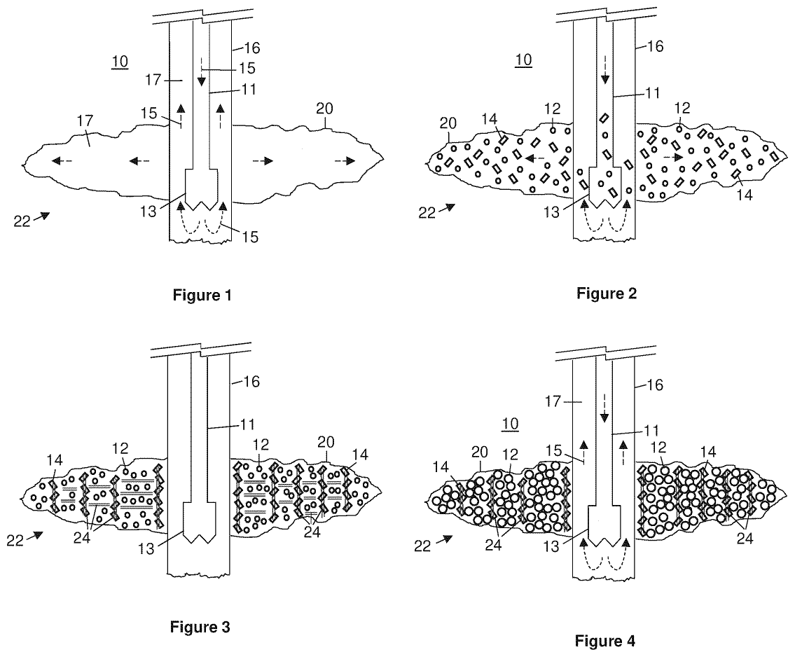

FIGS. 1 to 3 provide a schematic illustration of a method for creating a fluid barrier in a geological formation 10. Multiple applications may benefit from the creation of such a fluid barrier in the formation 10 for various purposes. However, for the purposes of providing an exemplary application, the following description generally relates to creating a fluid barrier in the formation 10 to reduce or prevent fluid losses to the formation 10 during a drilling operation.

FIG. 1 schematically illustrates a drilling operation performed in a formation 10 to create a wellbore 16. A drill bit 13, extending from surface via a drillstring 11, engages the formation 10 to drill the wellbore 16 producing cuttings which are returned to surface by a flow 15 of drilling fluid 17 through an annulus between the drillstring 11 and the formation 16. In this example, the formation 10 comprises a loss zone (i.e. a first zone 22) including a fracture 20 causing drilling fluid 17 to be lost to the formation 10 resulting in a partial loss of fluid 17 returns at surface. In this situation, it may be desirable to create a fluid barrier in the first zone 22 to reduce or prevent the fluid losses to the formation 10. As discussed in more detail below, a plurality of swellable particulates 12 and fibre elements 14 may be transported (e.g. pumped) through the drillstring 11 in a carrier fluid and into the fracture 20 of the first zone 22, as schematically illustrated in FIG. 2.

The swellable particulates 12 and fibre elements 14 are initially delivered into the wellbore 16 and the first zone 22 in a comingled state. FIG. 3 schematically illustrates the fibre elements 14 after being exposed to an adhesion activator causing the fibre elements 14 to adhere to one another and create a web arrangement 24 for constraining movement of the swellable particulates 12 in the first zone 22. The adhesion activator may be any suitable activator; however, in this example, the adhesion activator is defined by an activation temperature. The activation temperature may be selected to correspond to an anticipated temperature of the first zone 22. The fibre elements 14, when exposed to the adhesion activator, may comprise or exhibit an adhesive (e.g. tacky) characteristic, enabling the fibre elements 14 to adhere to one another and create the web arrangement 24. In this example, the web arrangement 24 is illustrated as an interconnected network of fibre elements 14; however, in other examples, the web arrangement 24 may comprise any shape or structure capable of constraining movement of the swellable particulates 12 in the first zone 22. The web arrangement 24 created by the fibre elements 14 may confine the swellable particulates 12 in the first zone 22 to prevent the swellable particulates 12 from moving to a more dispersed, relaxed position during and after the swelling process, thereby enhancing the fluid barrier created by the swellable particulates 12.

FIG. 4 schematically illustrates the swelling particulates after being exposed to a swelling activator causing the swellable particulates 12 to volumetrically swell and create a fluid barrier in the first zone 22, thus establishing a fluid restriction in the first zone 22 reducing or preventing fluid losses to the formation 10 through the first zone 22. The swelling activator may be any suitable activator; however, in this example the swelling activator is a fluid, such as water, and the swellable particulates 12 are configured to swell by osmosis.

FIGS. 1 to 4 illustrate the delivery of drilling fluid 17 into wellbore 16 being stopped before the swellable particulates 12 and fibre elements 14 are delivered into the wellbore 16; however, in other examples, the swellable particulates 12 and fibre elements 14 may be delivered into the wellbore 16 during the drilling operation, for example being incorporated into the drilling fluid 17 at surface for delivery into the wellbore 16.

Multiple other applications may benefit from the creation of such a fluid barrier in the formation 10. For example, the fluid barrier may be created to reduce or prevent fluid losses to the formation 10 during a cementing operation. In particular, the fluid barrier may be created to reduce or prevent a cement slurry delivered into an annulus in the wellbore 16 from being lost to the formation 10. In some examples, the swellable particulates 12 and fibre elements 14 may be delivered into the wellbore 16 before the cementing operation is performed to pre-empt losses to the formation 10 via the first zone 22.

The swellable particulates 12 may comprise a material configured to provide a desired swell strength, longevity under downhole conditions, and/or chemical resistance. The swellable particulates 12 may be configured to retain the swelling activator, once absorbed, to remain in the swelled condition for a perceived operational lifetime of the swellable particulates 12. The perceived operational lifetime may be based on an operational lifetime of the well (e.g. from production to abandonment), the expected operational lifetime of a reservoir associated with the well, or the expected operational lifetime of a neighbouring well (such as, an infill well), etc. The swellable particulates 12 may be non-degradable in the sense that they may be configured to withstand exposure to certain substances that the swellable particulates 12 may encounter during their operational lifetime. In this regard the swellable particulates 12 may be considered as permanent.

The carrier fluid may be any suitable fluid. In some examples, the carrier fluid is a water-based fluid, which may be a drilling fluid. The carrier fluid may comprise the swelling activator causing the swellable particulates 12 to partially swell as the swellable particulates 12 are transported through the wellbore 16. To prevent premature swelling of the swellable particulates 12, the swellable particulates 12 may comprise a coating configured to degrade at a predetermined stage in the process, e.g. after being delivered into the first zone 22. Alternatively, or in addition, the swellable particulates 12 may be configured to swell at a certain swell rate when exposed to the swelling activator to prevent the swellable particulates 12 from swelling to an undesirable extent prior to reaching the first zone 22. In other examples, the carrier fluid may not comprise the swelling activator. Instead, the swelling activator may be delivered into the wellbore 16 sometime after the swellable particulates 12 have been delivered into the wellbore 16. Alternatively, the method may comprise utilising a swelling activator present in the formation 10 or wellbore 16 and exposing the swellable particulates 12 to the swelling activator in the first zone 22.

The fracture 20 may vary in cross-sectional area along a length of the fracture 20, with the facture tip having a smaller area than a main section of the fracture 20. In the present example, the swellable particulates 12 and fibre elements 14 are dispersed throughout the fracture 20, bridging with one another towards the fracture tip. However, in other some examples, the swellable particulates 12 and fibre elements 14 may be configured to bridge with one another at or near an entrance or opening of the fracture 20 to prevent or reduce fluid loss into the fracture. The swellable particulates 12 may comprise a granular form having a grain size distribution between 5 and 1000 mesh, which may help effectively transport the swellable particulates 12 through the wellbore 16 and into the fracture 20.

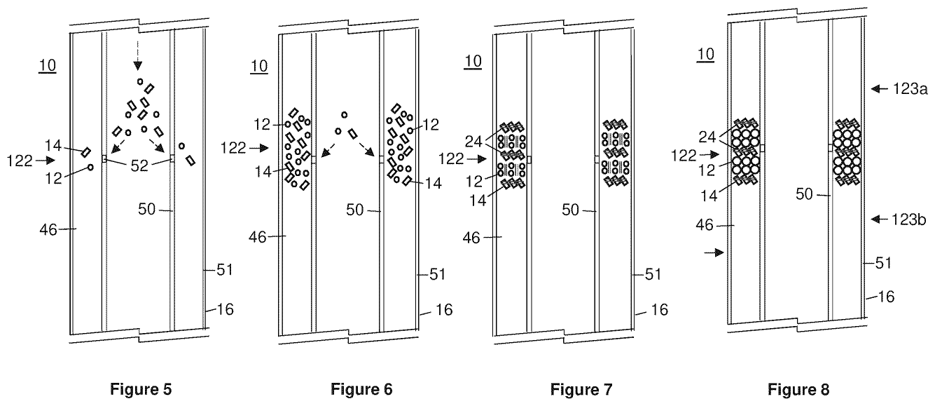

FIGS. 5 to 8 provide a schematic illustration of a method for creating a fluid barrier in a wellbore 16. Multiple applications may benefit from the creation of a fluid barrier in a wellbore 16 for various purposes. However, for the purposes of providing an exemplary application, the following description generally relates to creating a fluid barrier in an annulus 46 of the wellbore 16 to separate the wellbore 16 into segments.

FIGS. 5 and 6 schematically illustrate a plurality of fibre elements 14 and swellable particulates 12 being transported (e.g. pumped) in a carrier fluid in a downhole direction through tubing 50 in the wellbore 16. The tubing 50 comprises one or more ports 52 for the swellable particulates 12 and fibre elements 14 to be delivered into the annulus 46 (i.e. a first zone 122) between the tubing 50 and a casing 51. FIG. 7 schematically illustrates the fibre elements 14 after being exposed to an adhesion activator causing the fibre elements 14 to adhere to one another and create a web arrangement 24 for constraining movement of the swellable particulates 12 in the first zone 122. FIG. 8 schematically illustrates the swellable particulates 12 after being exposed to a swelling activator causing the swellable particulates 12 to volumetrically swell and create a fluid barrier separating the wellbore into segments 123a, 123b. In this regard the fluid barrier may function as an annular packer element.

FIGS. 9 to 12 provide a schematic illustration of another example of creating a fluid barrier in a wellbore 16. In this example, a fluid barrier is created in an annulus 46 of the wellbore 16 in a remedial operation to restore a sealing function of a defective seal element 48, such as a defective packer element.

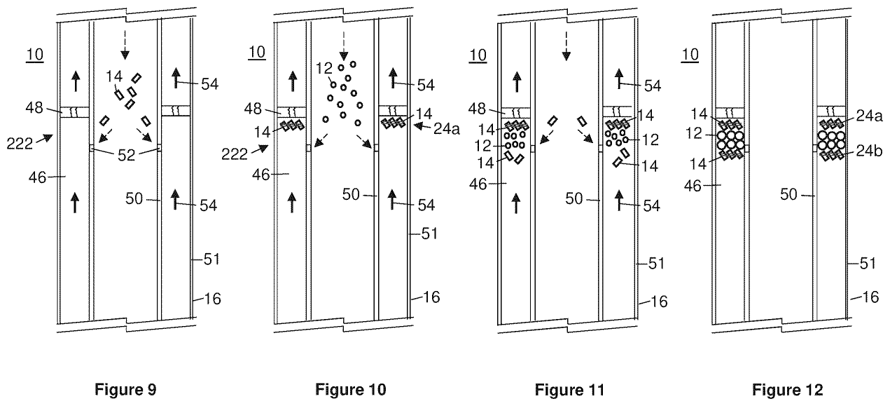

FIGS. 9 to 11 schematically illustrate a plurality of fibre elements 14 and swellable particulates 12 being transported (e.g. pumped) in a carrier fluid in a downhole direction through tubing 50 in the wellbore 16. In this example, the swellable particulates 12 and fibre elements 14 have been delivered into the wellbore 16 in a number of sequential stages. In a first stage, illustrated in FIG. 9, a first plurality of fibre elements 14 are delivered into the tubing 50, through the port 52 and into the annulus 46 of the wellbore 16 (i.e. a first zone 222). In a second stage, illustrated in FIG. 10, a plurality of swellable particulates 12 are delivered into the wellbore 16. In this example, the swellable particulates 12 are delivered into the wellbore 16 without fibre elements 14; however, in other examples the swellable particulates 12 may be delivered into the wellbore 16 with fibre elements 14 as illustrated in FIGS. 1 to 8. At this stage, the first plurality of fibre elements 14 have been exposed to the adhesion activator causing the fibre elements 14 to adhere to one another and create a first web arrangement 24a in the first zone 222, adjacent the defective seal element 48. The first web arrangement 24a of fibre elements 14 may provide a receiving area for the swellable particulates 12 to be deposited on. The fibre elements 14 may be transported through the wellbore 16 in a first carrier fluid and the swellable particulates 12 may be transported through the wellbore 16 in a second carrier fluid. The first carrier fluid may comprise an adhesion activator, and may be configured to encourage bridging of the fibre elements 14 in the annulus 46 of the wellbore 16, e.g. by comprising one or additives such as a viscosity agent. The second carrier fluid may comprise a swelling activator. Alternatively, the fibre elements 14 and swellable particulates 12 may be delivered into the wellbore 16 in the same carrier fluid.

In a third stage, illustrated in FIG. 11, a second plurality of fibre elements 14 are delivered into the wellbore 16. FIG. 12 schematically illustrates the second plurality of fibre elements 14 after being exposed to an adhesion activator causing the fibre elements 14 to adhere to one another and create a second web arrangement 24b. The second web arrangement 24b may provide additional stability to the swellable particulates 12 and resist movement of the swellable particulates 12 back into the wellbore 16. At the same time or a later stage, the swellable particulates 12 may be exposed to the swelling activator to create a fluid barrier and establish a restriction against flow 54 through the annulus 46, restoring a sealing function of the defective seal element 48 or replacing it entirely.

It will be appreciated that the method of delivering swellable particulates 12 and fibre elements 14 into the wellbore 16 in a single operation, as illustrated in FIGS. 1 to 8, may be used to create a fluid barrier in the wellbore 16 in a remedial operation, such as to restore a sealing function of the defective seal element 48 as illustrated in FIGS. 9 to 12. Similarly, the method of delivering swellable particulates 12 and fibre elements 14 into the wellbore 16 in a number of sequential stages, as illustrated in FIGS. 9 to 12, may be used to create a fluid barrier in the formation 10 to reduce or prevent fluid losses to the formation 10 (such as illustrated in FIGS. 1 to 4) or to separate the wellbore into segments (such as illustrated in FIGS. 5 to 8).

The present inventors performed laboratory testing in which a TWC-06 rubber sample (representing a mass of swellable particulates 12) was placed into a metal housing and allowed to swell in fresh water for 6 days at 110 °C. The rubber sample achieved 89% swelling of its initial un-swelled volume after the 6 days elapsed.

In addition, the present inventors performed laboratory testing demonstrating the plugging effects obtainable with and without fibre elements. In particular, a slotted test apparatus was provided and a piston cylinder was used to deliver a slurry mixture of water and swellable particulates (and, depending on the test performed, fibre elements) into a slot of the test apparatus. The piston cylinder included a sample chamber for receiving the slurry mixture and a pressure chamber for receiving pressurised gas to drive a piston to displace the slurry mixture from the sample chamber and into the slotted test apparatus. A valve was provided for opening and closing a flow path from the slotted test apparatus.

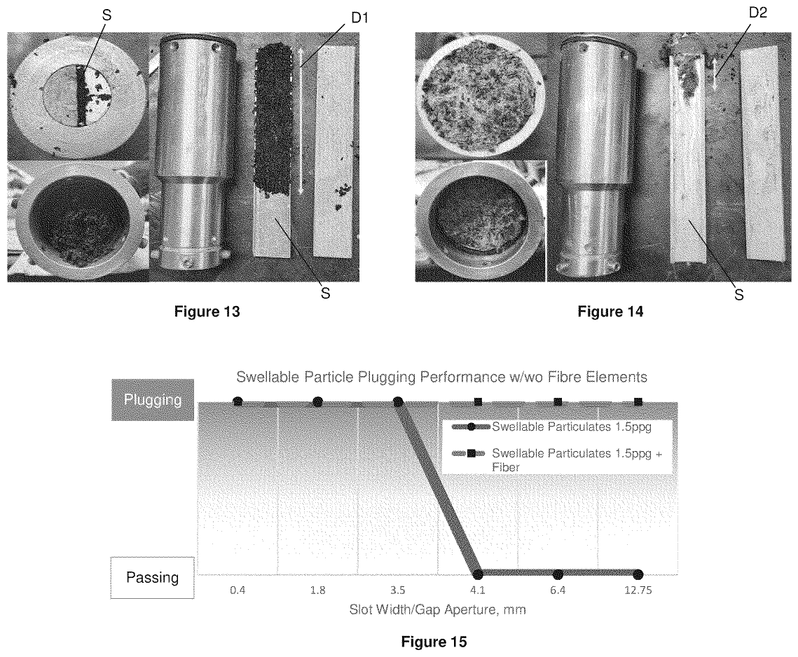

The test method comprised mixing one litre of water with 60 grams of swellable particulates (i.e., 0.5-1.5 lbs per gallon (0.06-0.18 g/ml) equivalent concentration) to provide a slurry mixture. The slurry mixture was delivered into the sample chamber and a pressure inside the pressure chamber was increased up to a pressure threshold of 50 psi (345 kPa). The valve was then opened and the slurry displaced through the slot of the slotted test apparatus was recorded every 15 seconds until the sample chamber had emptied. If the sample chamber had not emptied at 50 psi (345 kPa), the pressure inside the piston chamber was then increased in 50 psi (345 kPa) increments up to 200 psi (1.38 MPa), and the pressure at which plugging integrity was lost was recorded. The present inventors repeated the above tests for a slurry mixture also comprising temperature-activated fibre elements. FIGS. 13 and 14 are images taken from the slotted test apparatus after the tests described above had been performed, with and without fibre elements, respectively.

The size distribution for the coarse size of the swellable particulates used in the laboratory testing is provided in Table 1 below.

TABLE 1

| Microns | wt (g) | diff % | cum % |
|---|---|---|---|
| 710 | 17.6 | 88.9 | 88.9 |
| 500 | 0.4 | 1.9 | 90.8 |
| 355 | 0.3 | 1.5 | 92.3 |
| 250 | 0.3 | 1.4 | 93.7 |
| 180 | 0.29 | 1.5 | 95.2 |
| 150 | 0.13 | 0.7 | 95.9 |
| 90 | 0.33 | 1.7 | 97.5 |
| 70 | 0.09 | 0.5 | 98 |
| pan | 0.4 | 2 | 100 |

FIG. 13 shows the results of the test performed without fibre elements. The slotted test apparatus was set up to provide the slot S with a width of 4 mm. A slurry mixture with a concentration of 1.5 ppg (0.18 g/ml) of swellable particulates was used. As shown by the distance D1, which illustrates the length through the slot which the swellable particulates travelled before bridging, the amount of material lost through the slotted test apparatus is substantial. In practical terms, this would mean a large volume of material is required to provide a plug and seal across a fracture having similar dimensions. FIG. 14 shows the results of the test performed with the same 1.5 ppg (0.18 g/ml) mixture of swellable particulates but with the addition of the temperature-activated fibre elements. The fibre elements were added to the slurry mixture in a concentration of 3% by weight of swellable particulates. As illustrated by the distance D2, under the same slot testing conditions, a plug is formed very early on bridging the slot and limiting the loss of material. Therefore, the laboratory tests demonstrate that the fibre elements provide for improved consolidation of the slurry.

In practical terms, these results show that the addition of the fibre elements can improve bridging and reduce the amount of material required to create a robust plug and seal. A summary chart of the plugging results with and without fibre elements for different slot widths is illustrated in FIG. 15, which shows that the plugging potential of a given swellable particulate distribution can be extended with the addition of temperature-activated fibre elements. In particular, FIG. 15 illustrates the slot width at which seal integrity was lost when tested at pressures of around 200 psi (1.38 MPa). As can be seen, for slurry mixtures not comprising fibre elements, the seal integrity was lost at a slot width of 4.1 mm, only slightly above the 4 mm test described above. The slurry mixture comprising fibre elements, however, was able to maintain seal integrity up to a maximum slot width of the apparatus, 12.75 mm.

It is intended that the fibre elements bond to each other creating a web which promotes plugging of swellable particulates in higher slot widths. This enables the swellable particulates to seal larger loss zones. As such, the web formed by the fibre elements may substantially help improve the plugging performance under downhole conditions. As described hereinabove, in some examples, the fibre elements may not be activated at surface temperatures and conditions and therefore can be easily prepared and pumped using standard surface equipment and passing through pipework and completion restrictions. This same approach can be applied to a range of particle size distributions to enhance the bridging tendency and plugging potential in larger slots and in field applications for induced/natural fractures, vugs and intervals with substantial losses.

1. A method for creating a fluid barrier in a wellbore or a geological formation surrounding the wellbore, comprising:
delivering a plurality of swellable particulates into the wellbore and into a first zone in the wellbore or the formation, the plurality of swellable particulates configured to volumetrically swell to create a fluid barrier in response to exposure to a swelling activator; and
delivering a plurality of fibre elements into the wellbore and into the first zone, the fibre elements configured to adhere to one another to create a web arrangement for constraining movement of the swellable particulates in response to exposure to an adhesion activator.

2. The method of claim 1, comprising delivering the fibre elements and swellable particulates into the wellbore together in a single operation.

3. The method of claim 1, comprising delivering the fibre elements into the wellbore in a first stage and delivering the swellable particulates into the wellbore in a subsequent second stage.

4. The method of claim 3, wherein the plurality of fibre elements define a first plurality of fibre elements, and the method comprises delivering a second plurality of fibre elements into the wellbore in a subsequent third stage.

5. The method of claim 1, comprising delivering the swellable particulates into the wellbore in a first stage and delivering the fibre elements into the wellbore in a subsequent second stage.

6. The method of claim 1, comprising exposing the fibre elements to the adhesion activator to create the web arrangement of fibre elements in the first zone.

7. The method of claim 1, comprising exposing the swellable particulates to the swelling activator to create the fluid barrier in the first zone and establish a restriction against fluid flow.

8. The method of claim 1, comprising exposing the fibre elements to the adhesion activator before exposing the swellable particulates to the swelling activator.

9. The method of claim 1, wherein the first zone is a loss zone in the formation, and the method comprises delivering the swellable particulates and fibre elements into the first zone to reduce or prevent losses through the first zone.

10. The method of claim 9, comprising delivering the swellable particulates and fibre elements into the wellbore as part of a drilling operation.

11. The method of claim 9, comprising delivering the swellable particulates and fibre elements into the wellbore as part of a cementing operation.

12. The method of claim 9, comprising obstructing a fluid flow into the formation with the swellable particulates in the first zone.

13. The method of claim 1, wherein the first zone is a zone in the wellbore, and the method comprises delivering the swellable particulates and fibre elements into an annulus in the wellbore to separate the wellbore into segments.

14. The method of claim 1, wherein the first zone is a zone in the wellbore, and the method comprises delivering the swellable particulates and fibre elements into the wellbore to restore a function of a defective seal element in the wellbore.

15. The method of claim 1, wherein the first zone is a zone in the wellbore, and the method comprises delivering the swellable particulates and fibre elements into the wellbore to seal a perforation in a tubular element in the wellbore.

16. The method of claim 1, wherein the swelling activator and adhesion activator are different activators.

17. The method of claim 1, wherein the swelling activator is at least one of water and oil.

18. The method of claim 1, wherein the adhesion activator is defined by an activation temperature.

19. The method of claim 1, wherein the swellable particulates are configured to be substantially unaffected by substances the swellable particulates are expected to encounter during their operational lifetime.

20. The method of claim 1, comprising mixing the swellable particulates with the fibre elements for subsequent delivery into the wellbore in a premixed state.

21. The method of claim 1, wherein the swellable particulates comprise a coating configured to degrade after a certain duration of time.

22. The method of claim 1, wherein the swellable particulates are configured to swell at a certain swell rate in response to exposure to the swelling activator to provide the swellable particulates in a swelled condition after a certain duration of time.

23. The method of claim 1, wherein the fibre elements comprise a core-shell configuration.

24. The method of claim 1, comprising transporting the swellable particulates and fibre elements through the wellbore and into the first zone with a carrier fluid.

25. The method of claim 1, wherein the carrier fluid comprises the swelling activator.

26. The method of claim 1, comprising exposing the swellable particulates to the swelling activator only after the swellable particulates have been delivered into the first zone of the formation.

27. The method of claim 1, wherein the swellable particulates comprise a grain size distribution between 5 and 1000 mesh.

28. The method of claim 1, wherein the fibre elements comprise a length in a range of 1 to 25 mm.

29. The method of claim 1, wherein delivering the swellable particulates and fibre elements into the wellbore comprises pumping the swellable particulates and fibre elements into the wellbore.

30. A fluid treatment package comprising:
a plurality of swellable particulates for delivery into a wellbore and into a first zone in the wellbore or the formation, the plurality of swellable particulates configured to volumetrically swell to create a fluid barrier in response to exposure to a swelling activator; and
a plurality of fibre elements for delivery into the wellbore and into the first zone, the fibre elements configured to adhere to one another and create a web arrangement for constraining movement of the swellable particulates in response to exposure to an adhesion activator.
